(19) United States
(12) Patent Application Publication
(10) Pub. No.: US 2011/0109522 A1
(43) Pub. Date: May 12, 2011

(54) Multiband antenna with GPS digital output

(76) Inventors: Michael Merrick, Novi, MI (US); Rus Leelaratne, Sittingbourne (GB); Andrew Nogoy, Novi, MI (US); David Simmonett, Sittingbourne (GB)

(21) Appl. No.: 12/924,879

(22) Filed: Oct. 7, 2010

Related U.S. Application Data
(60) Provisional application No. 61/278,495, filed on Oct. 7, 2009.

(51) Int. Cl. H01Q 1/42

(52) U.S. Cl. 343/872

(57) ABSTRACT

A multiband antenna with GPS digital output comprising a housing, a GPS antenna provided in the housing, an AM/FM antenna provided on the housing, at least a GPS receiver provided in the housing and coupled to the GPS antenna and a serial network bus provided in the housing and coupled to the GPS receiver whereby AM/FM signals and GPS digital output is provided from the multiband antenna.

### I. BACKGROUND OF THE INVENTION

1. Field of Invention:

The present invention relates to multiband antennas for AM/FM, GPS and SDARS and particularly relates to a multiband antenna which includes an AM/FM antenna, a SDARS/GPS antenna and means for outputting a SDARS radio frequency signal, a AM/FM signal and GPS information in a digital output from an integrated unit.

2. The Prior Art:

In the prior art there exists AM/FM antennas, GPS antennas and SDARS antennas. Such antennas operate with and are connected to elements in a motor vehicle so as to provide the driver with not only entertainment but driving information. However, the prior art devices and antennas are distributed in the motor vehicle and the connection and utilization of said devices and antennas is complex, hard to assemble and expensive.

### II. SUMMARY OF THE INVENTION

Accordingly it is a general object of the present invention to provide a multiband antenna with GPS digital output which is integrated, low in cost and easy to install.

The above mentioned features and objects of the present invention are accomplished utilizing a multiband antenna with GPS and digital outputs including a module housing, a SDARS (Satellite Digital Audio Radio Service signals)/GPS (Global Positioning System) antenna provided in the housing, an AM/FM antenna provided on the housing, a GPS receiver means provided on the housing and coupled to said SDARS/GPS antenna and a network interface means provided in said housing and coupled to said GPS receiver means whereby said housing has AM/FM signal, SDARS signal and network output means.

### III. BRIEF DESCRIPTION OF THE DRAWINGS

The above mentioned features and objects will become more apparent when taken with the accompanied drawings wherein like reference numerals denote like elements and in which:

FIG. 1 is an electrical block diagram of one embodiment of the present invention;

FIG. 2 is a simplified drawing illustrating the physical appearance of the present invention; and

FIGS. 3(A) and 3(B) are respectively the top and bottom sides of a circuit board housing the component of the present invention.

### IV. DETAILED DESCRIPTION OF THE INVENTION

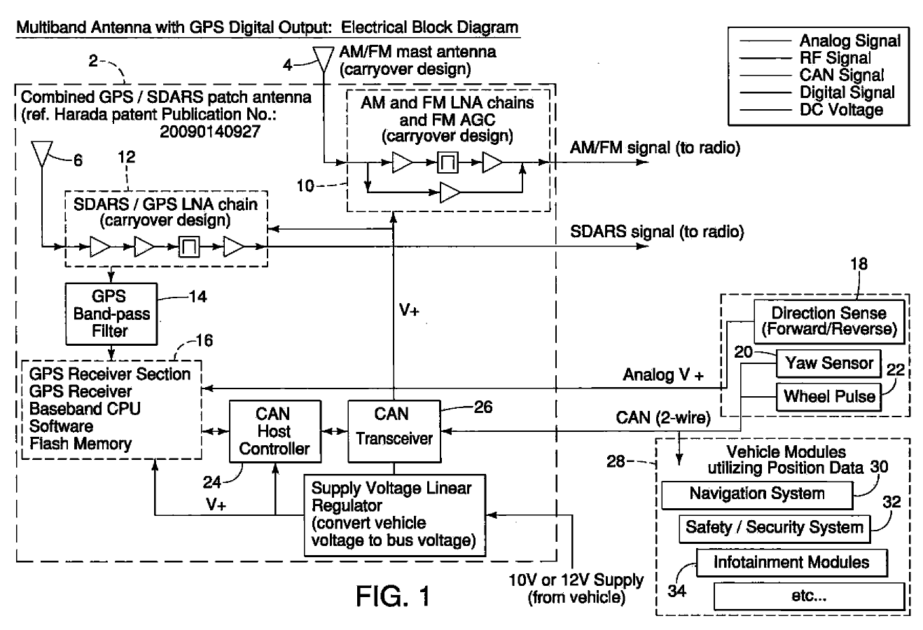

Referring to the FIGS. 1, 2, 3(A) and 3(B) shown therein is one embodiment of a multiband with GPS digital output in accordance with the present invention.

In particular, the multiband antenna includes a housing 2, an AM/FM antenna 4 coupled to the housing 2 and a combined GPS/SDARS patch antenna such as is disclosed in U.S. patent publication no. 2009/0140927 provided in the housing 2. The combined GPS/SDARS patch antenna 6 is provided on the top surface of the printed circuit board 8. The AM/FM antenna 4 is connected to an AM/FM LNA chain and FM AGC 10 which is provided inside the housing 2. The output of the AM/FM chain and AGC forms and external output comprising an AM/FM signal which goes to the AM/FM radio provided in the motor vehicle.

The combined GPS/SDARS antenna 6 is connected to a SDARS/GPS LNA chain 12 which is provided on the underside of the printed circuit board 8. The SDARS/GPS LNA chain comprises amplifiers and a filter and provides the SDARS radio frequency signal which goes to the satellite radio in the motor vehicle.

The combined GPS/SDARS patch antenna is further coupled to a GPS ban pass filter 14 which is also provided in the housing 2. The output of the ban pass filter 14 is coupled to a GPS receiver section 16 which comprises a GPS receiver, base band CPU, a flash memory and software stored on the flash memory. The GPS receiver section 16 is provided on the underside of the printed circuit board 8. Also provided to the GPS receiver section 16 are outputs from the direction sensor 18, yaw sensor 20 and wield pulse sensor 22. The information from the sensors 18, 20 and 22 are provided via the control area network serial bus (CAN) in the motor vehicle to the GPS receiver section 16 so that the GPS receiver section 16 can compute and send the position data via the CAN host controller 24, CAN transceiver 26 to the vehicle modules utilizing the position data 28 which comprises the navigation system 30, safety and security system 32, infotainment modules 34 and others. The 10-12 volt DC power supply from the vehicle is supplied via the cabling to a supply voltage linear regulator provided within the housing 2 which then provides the power to all the active elements in the housing 2 of the multiband antenna with GPS digital output.

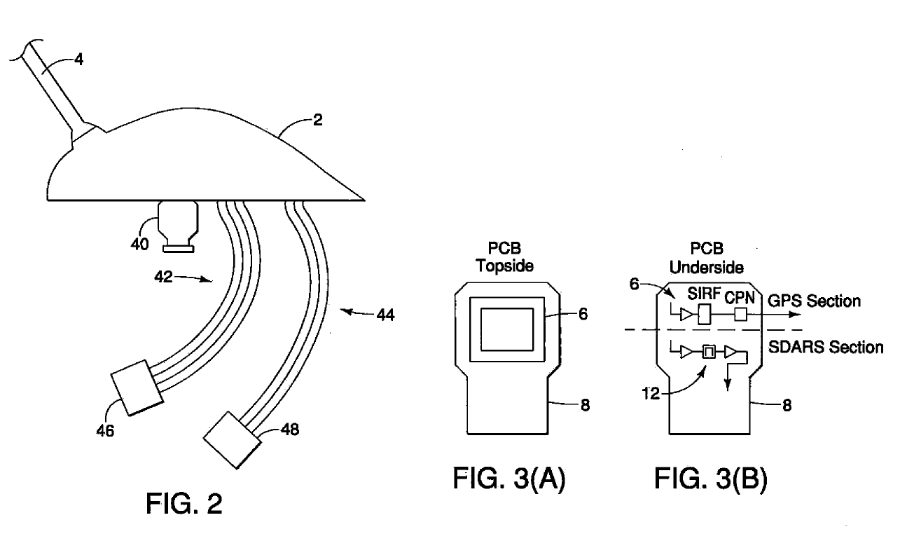

Referring particularly to FIG. 2, the housing 2 is further provided with an integrated bolt mechanism 40 designed to protrude through a motor vehicle roof into the interior and fix the multiband antenna to the roof of the motor vehicle. In addition, from the housing comes out the radio frequency cabling 42 and the power and CAN wires 44. The radio frequency cables 42 are provided to a standard dual FAKRA connector 46 which is well known in the motor vehicle art, while the wires 44 are provided to a standard 4-wire connector 48.

In operation, the multiband antenna of the present invention receives AM/FM signals via the AM/FM antenna 4 and provides them to the AM/FM radio in the motor vehicle. The SDARS/GPS antenna 6 provided in the housing 2 provides satellite digital audio radio service signals to the satellite radio provided in the motor vehicle and also provides signals to the GPS receiver section 16 which based thereon provides digital signals via the CAN serial bus to the required vehicle modules utilizing position data such as the navigation system 30. In addition the direction sensor 18, yaw sensor 20 and wheel pulse sensor 22 provide information via the CAN serial bus to the GPS receiver section 16 so that dead reckoning data as to the position of the motor vehicle can be calculated.

It should be apparent to those skilled in the art that this embodiment represents a single embodiment of the present invention and varied other arrangements can be created without departing from the spirit and scope of the invention.

I claim:

1. A multiband antenna with GPS digital output comprising a module housing, a SDARS/GPS antenna provided in the housing, an AM/FM antenna provided on the housing, a GPS receiver means provided in the housing and coupled to the SDARS/GPS antenna and a network interface means provided in said housing and coupled to said GPS receiver means whereby said housing has AM/FM signal, SDARS signal and network output means.
